(19) United States
(12) Patent Application Publication
(10) Pub. No.: US 2025/0186814 A1
(43) Pub. Date: Jun. 12, 2025

(54) Hip Worn Storage Assembly

(71) Applicant: Tethrd Inc, Columbia, TN (US)

(72) Inventors: Walter Power, II, Columbia, TN (US); Gregory Alan Godfrey, Richmond Hill, GA (US); Shawn Paul Chadwick, Merrill, WI (US); Carl Eugene Kossuth, III, St. James, MO (US)

(73) Assignee: Tethrd Inc., Columbia, TN (US)

(21) Appl. No.: 18/533,106

(22) Filed: Dec. 7, 2023

(51) Int. Cl. A62B 35/00; A45C 13/10; A45F 3/00; A45F 3/14

(52) U.S. Cl. CPC A62B 35/0025; A45C 13/103; A45F 3/14; A45F 2003/003

(57) ABSTRACT

A hip worn storage assembly for providing readily accessible storage for a user of a hunting saddle includes a pair of hip bags, each of which defines an interior space and has a top, a bottom, front and rear faces, and inner and outer sides. Each hip bag has a slit positioned substantially equidistant from the inner and outer sides. A semirigid member attached to the hip bag and coextensive with the slit allows the user to access the interior space. Primary closures attached to the hip bags proximate to the slits are used to selectively close the slits. The hip bags can be attached to an upper strap of a saddle of a safety harness assembly so that each hip bag is positioned proximate to an associated hip of the user upon donning of the safety harness assembly.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to safety harness attached storage devices and more particularly pertains to a new safety harness attached storage device for providing readily accessible storage for a user of a hunting saddle.

### (2) Description of Related Art Including Information Disclosed Under 37 CFR 1.97 and 1.98

The prior art relates to safety harness attached storage devices. These safety harnesses are secured to trees to prevent a person from falling from the tree while hunting, for example, and it is desirable to have storage devices attached to, or attachable to, the safety harnesses to stow items useful in hunting. However, prior art storage devices for safety harnesses may not fit tightly to the users, be prone to snagging on underbrush, and may not be operable using one hand.

### BRIEF SUMMARY OF THE INVENTION

An embodiment of the disclosure meets the needs presented above by generally comprising a pair of hip bags, each of which defines an interior space and each of which has a top, a bottom, a front face, a rear face, an inner side, and an outer side. Each hip bag has a slit positioned substantially equidistant from the inner side and the outer side. The slit is configured to allow a user to access the interior space and extends from proximate to the rear face through the top and the front face to proximate to the bottom. A plurality of primary closures is attached to the hip bags, proximate to the slits, so that each hip bag is fitted with at least one primary closure. The primary closures are configured to selectively close the slits. Each bag is fitted with a semirigid member that is located proximate and parallel to the slit to provide structure to the hip bag and to facilitate one hand operation by providing rigidity to the primary closure. The pair of hip bags is configured for attachment to an upper strap of a saddle of a safety harness assembly so that each hip bag is positioned proximate to an associated hip of the user upon donning of the safety harness assembly.

Another embodiment of the disclosure includes a single bag hip worn storage system, which comprises a safety harness assembly and a hip bag, according to the disclosure above. The safety harness assembly comprises a saddle having an upper strap. The hip bag is attached to the upper strap so that the hip bag is positioned proximate to an associated hip of a user upon donning of the safety harness assembly.

Yet another embodiment of the disclosure includes a dual bag hip worn storage system, which comprises a safety harness assembly and a pair of hip bags, according to the disclosure above. The safety harness assembly comprises a saddle having an upper strap. The pair of hip bags is attached to the upper strap so that each hip bag is positioned proximate to an associated hip of a user upon donning of the safety harness assembly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric perspective view of a hip worn storage assembly according to an embodiment of the disclosure.

FIG. 2 is a rear isometric perspective view of an embodiment of the disclosure.

FIG. 3 is a front view of an embodiment of the disclosure.

FIG. 4 is a rear view of an embodiment of the disclosure.

FIG. 5 is an in-use view of an embodiment of the disclosure.

FIG. 6 is an in-use view of an embodiment of the disclosure.

FIG. 7 is a front isometric perspective view of an embodiment of the disclosure.

### DETAILED DESCRIPTION OF THE INVENTION

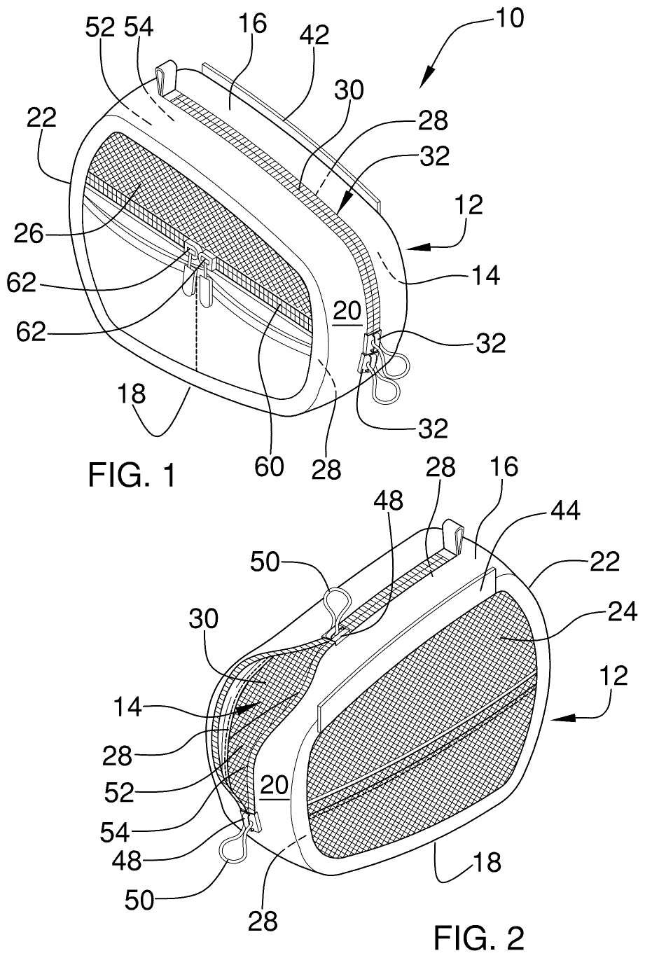

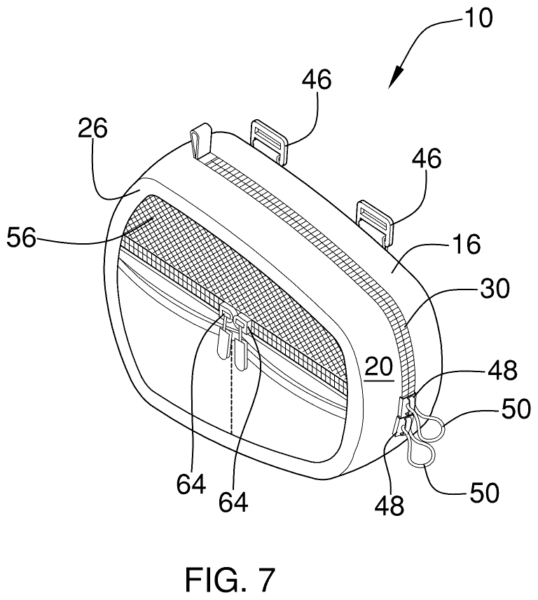

With reference now to the drawings, and in particular to FIGS. 1 through 7 thereof, a new safety harness attached storage device embodying the principles and concepts of an embodiment of the disclosure and generally designated by the reference numeral 10 will be described.

As best illustrated in FIGS. 1 through 7, the hip worn storage assembly 10 generally comprises a pair of hip bags 12, which typically would comprise flexible or semiflexible fabric. Each hip bag 12 defines an interior space 14 and has a top 16, a bottom 18, a front face 20, a rear face 22, an inner side 24, and an outer side 26. The rear face 22 of each hip bag 12 may be dimensionally taller than the front face 20 so that the top 16 tapers downwardly from the rear face 22 to the front face 20, and such that the bottom 18 tapers upwardly from the rear face 22 to the front face 20. As will become apparent, this shaping of the hip bags 12 reduces the profile and drag of the hip bag while walking or running through tight corridors or brush. The rear face 22 and the front face 20 may be convexly arcuate when viewed from the outer side 26, thereby giving the rear face 22 and the front face 20 a distorted oval shape and reducing risk of snagging when traversing through brush and complement the shape of a safety harness assembly 38 . . . . The present invention also anticipates the rear face 22 and the front face 20 being alternatively shaped, such as, but not limited to, wedge shaped, ovally shaped, or the like.

Each semirigid member 28 of a plurality of semirigid members 28 is attached to a respective hip bag 12 and is positioned in the interior space 14. Each hip bag 12 is fitted with at least one semirigid member 28 that extends circumferentially around the hip bag 12 in parallel with the inner side 24, as is shown in FIG. 2. The semirigid members 28 are may be formed as a rod, a tube, a band, or the like, and may comprise plastic, aluminum, titanium, or the like, and thus be semiflexible. As will become apparent below, the semirigid members 28 being semiflexible allows the hip bags 12 to mold, at least partially, to contours of the hips of a user, thereby retaining the hip bags 12 in a tight relationship with the hips and reducing a risk of snagging branches, or the like, when traversing to a hunting site. Each hip bag 12 may be fitted with additional semirigid members 28. For example, one or both of the inner side 24 and the outer side 26 may have a semirigid member 28 positioned adjacent thereto.

Each hip bag 12 has a slit 30 positioned therein substantially equidistant from the inner side 24 and the outer side 26. The slit 30 is configured to allow the user to access the interior space 14 and extends from proximate to the rear face 22 through the top 16 and the front face 20 to proximate to the bottom 18. A plurality of primary closures 32 is attached to the hip bags 12, proximate to the slits 30, so that each hip bag 12 is fitted with at least one primary closure 32. The primary closures 32 are configured to selectively close the slits 30. The semirigid member 28 is located proximate and parallel to the slit 30 to improve the rigidity of the primary closure 32 and thereby facilitates one hand operation by the user. Most typically, the semirigid member 28 is located between the slit 30 and the inner side 24.

The pair of hip bags 12 is configured for attachment to an upper strap 34 of a saddle 36 of the safety harness assembly 38 so that each hip bag 12 is positioned proximate to an associated hip of the user upon donning of the safety harness assembly 38. The hip bags 12 are anticipated to be of significant use to hunters using safety harness assemblies 38 for hunting from elevated platforms. The interior spaces 14 of the hip bags 12 provide a significant volume of storage space for hunting related items to which the user requires quick and quiet access. Of note is the hip bags 12 being primary attached to the upper strap 34 of the saddle 36, thereby allowing the upper strap 34 and the lower strap 40 to separate as the user positions their buttocks into the saddle 36.

The present invention anticipates the pair of hip bags 12 being fixedly attached to the upper strap 34. For example, the pair of hip bags 12 may be stitched to the upper strap 34. The hip bags 12 also may be reversibly attachable to the upper strap 34 by a plurality of couplers 42. The plurality of couplers 42 is attached to the pair of hip bags 12 so that each hip bag 12 is fitted with at least one coupler 42, which is positioned on the rear face 22 proximate to the top 16. One or more additional couplers 42 may be attached the hip bag 12, proximate to the bottom 18 of the hip bag 12, and be configured to releasably attach the hip bag 12 to a lower strap 34 of the saddle 36 or to the saddle 36 proximate to the lower strap.

Each coupler 42 may comprise a strip 44, which is attached to the inner side 24 and which extends along and upwardly past the top 16. The strip 44 is configured to overlay and to be stitched to the upper strap 34, thereby fixedly attaching the hip bag 12 to the upper strap 34. The strip 44 may comprise the same material as the upper strap 34 of the saddle 36 and thus be configured to stretch, or flex, and to rebound concurrently with the upper strap 34.

The plurality of couplers 42 may comprise a plurality of first attachments 46, which is attached to the pair of hip bags 12 so that each hip bag 12 is fitted with two first attachments 46 attached to the inner side 24. The two first attachments 46 are configured to attach to two second attachments (not shown), which are attached to the upper strap 34, thereby attaching the hip bag 12 to the upper strap 34. These type of attachments are commonly referred to as Modular Lightweight Load-carrying Equipment (MOLLE) attachments or Pouch Attachment Ladder System (PALS) attachments. The present invention also anticipates the couplers 42 comprising other coupling means, such as, but not limited to, hook and loop fasteners, button closures, snap closures, or the like. However, these alternative coupling means are not anticipated to provide the same level of security as is provided by attachment of the strip 44 by stitching or by the use of MOLLE or PALS attachments.

Each primary closure 32 may comprise a primary zipper 48, with each hip bag 12 being fitted with one primary zipper 48 that opens the slit 30 from the front face 20 to the rear face 22. As is shown in FIG. 2, each hip bag 12 is fitted with two primary zippers 48. One primary zipper 48 opens the slit 30 from the front face 20 to the rear face 22 and the other primary zipper 48 opens the slit 30 from the rear face 22 to the front face 20. The use of two primary zippers 48 provides another degree of freedom to the user in opening and closing the slits 30. While the primary closure 32 is anticipated to comprise other closing means, such as, but not limited to, hook and loop fasteners, button closures, snap closures, or the like, these closing means are not preferred as they are less amenable to one handed operation.

Each ring 50 of a plurality of rings 50 is attached to a respective primary zipper 48 so that each primary zipper 48 is fitted with a ring 50. The ring 50 is configured for insertion of a digit of a hand of the user motivate the primary zipper 48 to open and to close an associated slit 30. The primary zippers 48 and their attached rings 50 are critical to functioning of the hip worn storage assembly 10 as they allow the user to easily access the interior space 14 of each hip bag 12, using only one hand, and to subsequently close the slit 30, again using only one hand. More specifically, the hip bag 12 positioned proximate to the right hip of the user is readily accessed using the right hand of the user and the hip bag 12 positioned proximate to the left hip of the user is readily accessed using the left hand of the user.

The hip worn storage assembly 10 also may comprise a plurality of inner panels 52, which is attached to the pair of hip bags 12 and which defines a plurality of inner pouches 54 that is positioned in the interior spaces 14 of the hip bags 12. Each inner pouch 54 is configured for insertion of a respective item useful in hunting from a tree stand. Any number of inner panels 52 in any number of configurations is anticipated by the present invention.

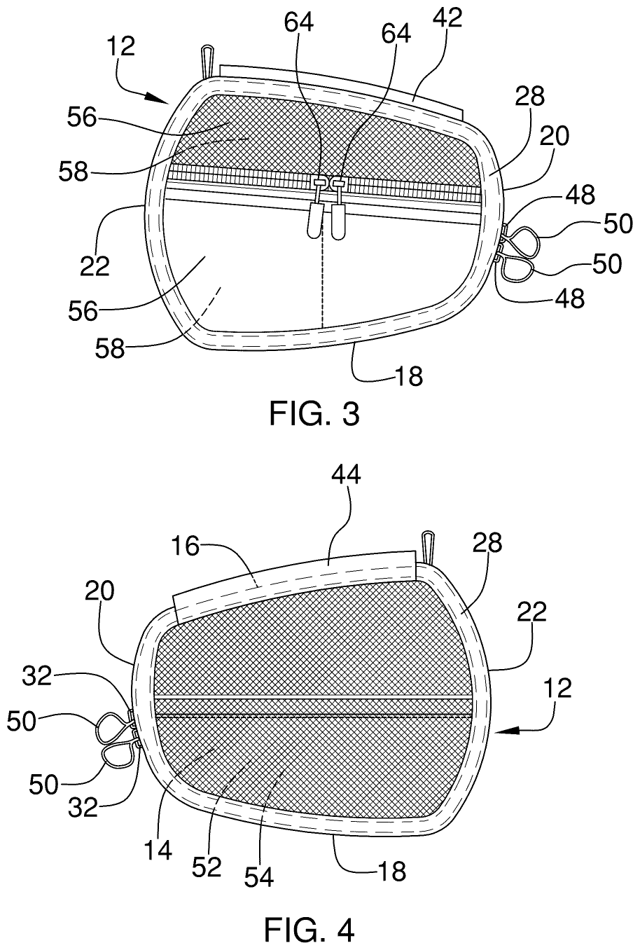

The hip worn storage assembly 10 also may comprise a plurality of outer panels 56, the outer panels 56 of which are attached to the outer sides 26 of the pair of hip bags 12 defining a plurality of outer pockets 58. The outer panels 56 may comprise flexible mesh or a solid material, as is shown in FIG. 3, or a combination thereof. Respective outer pockets may be closable by means of secondary closures 62, such as secondary zippers 64. The present invention anticipates outer panels 56 being attached in a variety of configurations providing openings approximately parallel to the top 16 of the hip bag 12 to facilitate one handed operation.

The inner pouches 54 and the outer pockets 58, along with the interior space 14 of the hip bags 12, provide significant storage capacity and opportunities for organization of a variety of articles and items required for hunting from an elevated platform using the safety harness assembly 38 in relative comfort and with increased efficiency.

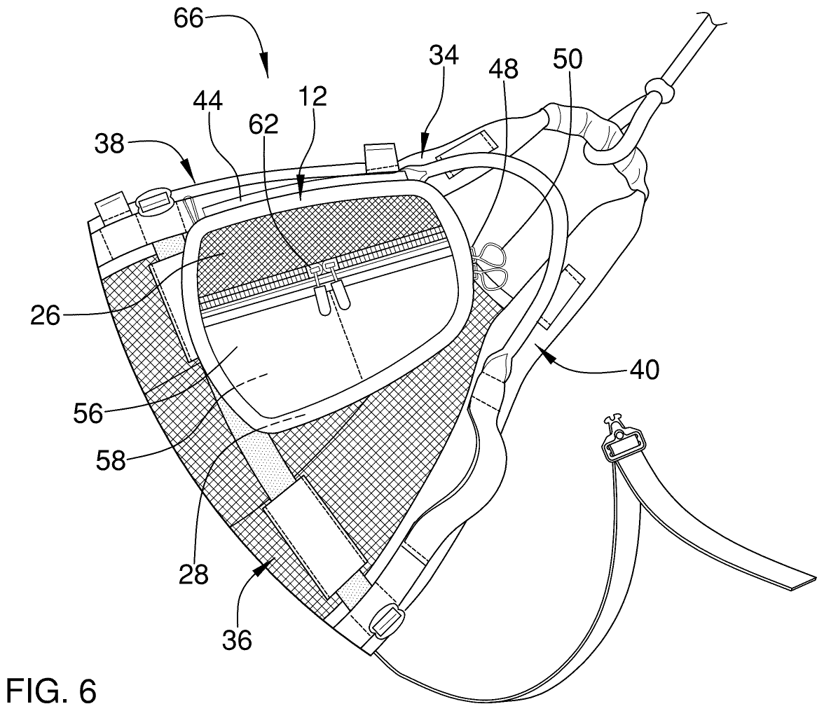

Also anticipated is a single bag hip worn storage system 66, which comprises a safety harness assembly 38 and a single hip bag 12, as is shown in FIG. 6. The safety harness assembly 38 comprises a saddle 36 having an upper strap 34. The hip bag 12 is attached to the upper strap 34 so that the hip bag 12 is positioned proximate to an associated hip (the right hip in FIG. 6) of a user upon donning of the safety harness assembly 38.

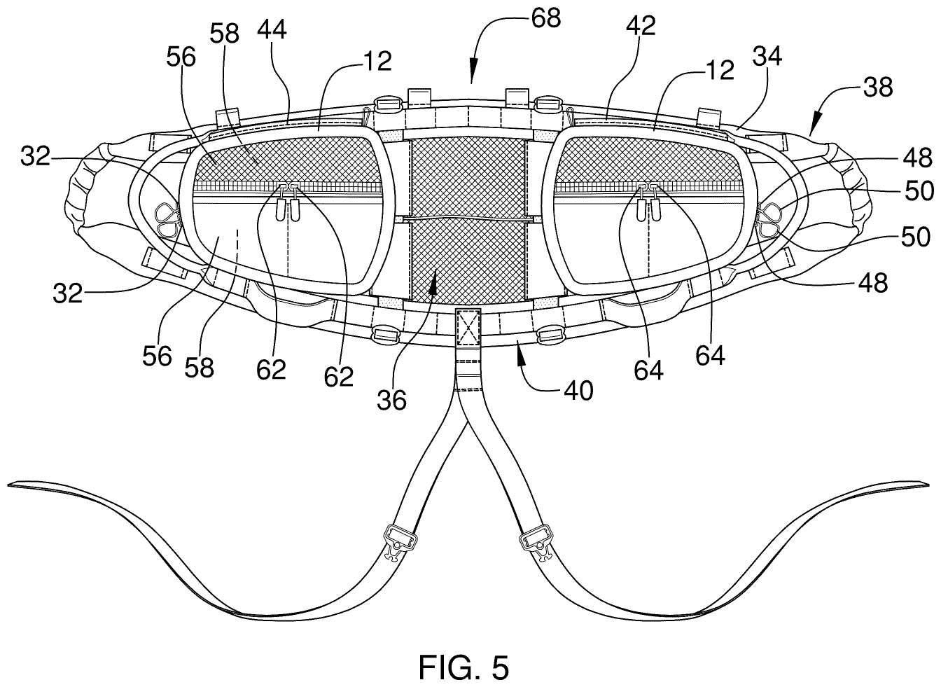

Additionally anticipated is a dual bag hip worn storage system 68, which comprises a safety harness assembly 38 and a pair of hip bags 12, as is shown in FIG. 5. The safety harness assembly 38 comprises a saddle 36 having an upper strap 34. The pair of hip bags 12 is attached to the upper strap 34 so that each hip bag 12 is positioned proximate to an associated hip of a user upon donning of the safety harness assembly 38.

In use, the safety harness assembly 38 with the hip bags 12 attached is donned by the user. The articles and items desired by the user for the hunt can be stowed and organized using the pair of hip bags 12 and readily accessed as needed and using only one hand.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hip worn storage assembly comprising:
a pair of hip bags, each hip bag defining an interior space and having a top, a bottom, a front face, a rear face, an inner side, and an outer side, each hip bag having a slit positioned equidistant from the inner side and the outer side, wherein the slit is configure for accessing the interior space, the slit extending from proximate to the rear face through the top and the front face to proximate to the bottom, the pair of hip bags being configured for attachment to an upper strap of a saddle of a safety harness assembly, such that each hip bag is positioned proximate to an associated hip of a user upon donning of the safety harness assembly;
a plurality of primary closures attached to the hip bags proximate to the slits, such that each hip bag is fitted with at least one primary closure, the primary closures being configured to selectively close the slits; and
a pair of semirigid members each being attached singly to the hip bag such that each semirigid member is proximate and parallel to the slit of the hip bag.

2. The hip worn storage assembly of claim 1, wherein the pair of hip bags is fixedly attached to the upper strap.

3. The hip worn storage assembly of claim 2, wherein the pair of hip bags is stitched to the upper strap.

4. The hip worn storage assembly of claim 1, further including a plurality of couplers attached to the pair of hip bags, such that each hip bag is fitted with at least one coupler positioned on the rear face proximate to the top, the couplers being configured for attaching the hip bags to the upper strap of the saddle.

5. The hip worn storage assembly of claim 4, wherein each coupler comprises a strip attached to the inner side and extending along the top, wherein the strip is configured to overlay and to be coupled to the upper strap.

6. The hip worn storage assembly of claim 4, wherein the plurality of couplers comprises a plurality of first attachments attached to the pair of hip bags, such that each hip bag is fitted with two first attachments attached to the inner side, wherein the two first attachments are configured for attaching to two second attachments attached to the upper strap, thereby attaching the hip bag to the upper strap.

7. The hip worn storage assembly of claim 1, wherein the rear face of each hip bag is dimensionally taller than the front face, such that the top tapers downwardly from the rear face to the front face, and such that the bottom tapers upwardly from the rear face to the front face.

8. The hip worn storage assembly of claim 1, wherein the rear face and the front face are convexly arcuate when viewed from the outer side.

9. The hip worn storage assembly of claim 1, wherein each semirigid member is endless, positioned in the interior space and extends along the front face, bottom face, and rear face of the hip bag, such that the hip bag is retained in an expanded configuration.

10. The hip bag storage assembly of claim 9, wherein each semirigid member is located proximate and parallel to the inner side of the hip bag storage assembly.

11. The hip bag storage assembly of claim 9, wherein each semirigid member is located proximate and parallel to the outer side of the hip bag storage assembly.

12. The hip worn storage assembly of claim 1, wherein each primary closure comprises a primary zipper, each hip bag being fitted with one primary zipper opening the slit from the front face to the rear face.

13. The hip worn storage assembly of claim 1, wherein each primary closure comprises a primary zipper, each hip bag is fitted with two primary zippers with one primary zipper opening the slit from the front face to the rear face and the other primary zipper opening the slit from the rear face to the front face.

14. The hip worn storage assembly of claim 12, further including a plurality of rings, each ring being attached to a respective primary zipper, such that each primary zipper is fitted with a ring, wherein the ring is configured for insertion of a digit of a hand of the user motivating the primary zipper for opening and closing an associated slit.

15. The hip worn storage assembly of claim 13, further including a plurality of rings, each ring being attached to a respective primary zipper, such that each primary zipper is fitted with a ring, wherein the ring is configured for insertion of a digit of a hand of the user motivating the primary zipper for opening and closing an associated slit.

16. The hip worn storage assembly of claim 1, further including a plurality of inner panels attached to the pair of hip bags and defining a plurality of inner pouches positioned in the interior spaces of the hip bags, wherein each inner pouch is configured for insertion of a respective item.

17. A single bag hip worn storage system comprising:
a safety harness assembly comprising a saddle having an upper strap; and
a hip bag according to claim 1 being attached to the upper strap, such that the hip bag is positioned proximate to an associated hip of a user upon donning of the safety harness assembly.

18. A dual bag hip worn storage system comprising:
a safety harness assembly which includes a saddle having an upper strap; and
a pair of hip bags according to claim 1 being attached to the upper strap, such that each hip bag is positioned proximate to an associated hip of a user upon donning of the safety harness assembly.
